(19) United States
(12) Patent Application Publication
(10) Pub. No.: US 2018/0114172 A1
(43) Pub. Date: Apr. 26, 2018

(54) ONLINE COLLABORATION OF TASK ASSIGNMENT

(71) Applicant: INTERNATIONAL BUSINESS MACHINES CORPORATION, Armonk, NY (US)

(72) Inventors: THEMBANI TOGWE, LENEXA, KS (US); MICHAEL J. WHITNEY, CARY, NC (US)

(21) Appl. No.: 15/298,320

(22) Filed: Oct. 20, 2016

(51) Int. Cl. G06Q 10/06; G06F 17/27

(52) U.S. Cl. CPC G06Q 10/063112; G06Q 10/063114; G06F 17/274; G06F 17/2765

(57) ABSTRACT

Embodiments provide a method for online collaborations task assignment The method includes monitoring a collaboration session, and analyzing statements of the collaboration session. The method also includes determining a statement type for the statements of the collaboration session, and classifying the statements as a statement type. The method includes assigning statements classified as a task to a participant based on the analysis, and updating a participant experience profile based on analyzing statements of the collaboration session.

### BACKGROUND

The present invention relates to task assignment and management, and more specifically, to a method for online collaboration of task assignment.

In today's environment, online collaborations are commonly used in personal and enterprise settings. Online collaborations provide an opportunity for several members to exchange ideas in real-time. Online collaborations can provide different services using various applications including teleconferences, web conferences, chat sessions, and the like. Online collaborations provide an array of features such as speech-to-text capability, text-to-speech capability, video capability, media sharing capability, and more. Also, online collaborations allow members in various locations to contribute synchronously or asynchronously to a current session.

Various types of data and media can be shared in the virtual collaborations. For example, task lists, videos, whiteboards, documents, etc. can be shared with conference members in real-time or after the fact. In addition, members are able to participate in online collaborations using various devices including desktop computers, laptops, and mobile devices allowing individuals to participate in conferences while traveling.

### SUMMARY

According to an embodiment, a computer-implemented method for online collaboration of task assignment is provided. The method includes monitoring a collaboration session and analyzing statements of the collaboration session. The method also includes determining a statement type for the statements of the collaboration session and classifying the statements as a statement type. The method includes assigning statements classified as a task to a participant based on the analysis, and updating a participant experience profile based on analyzing statements of the collaboration session.

According to another embodiment, a system for online collaboration of task assignment is provided. The system includes a memory coupled to a processor, and a processing engine configured to monitor a collaboration session, and analyze statements of the collaboration session. The processing engine is further configured to determine a statement type for the statements of the collaboration session, classify the statements as a statement type, and assign statements classified as a task to a participant based on the analysis. The processing engine is configured to update a participant experience profile based on analyzing statements of the collaboration session, the participant experience profile comprises a participant experience score.

A computer program product for online collaboration of task assignment is provided. The computer program product includes a computer readable storage medium having stored thereon program instructions executable by a processor to cause the processor to monitor a collaboration session, and analyze statements of the collaboration session. The processor is further configured to determine a statement type for the statements of the collaboration session, classify the statements as a statement type, and assign statements classified as a task to a participant based on the analysis. The processor is configured to update a participant experience profile based on analyzing statements of the collaboration session, the participant experience profile comprises a participant experience score.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 is a flow diagram for an online collaboration of task assignment in accordance with an embodiment;

FIG. 3 is a flow diagram for an online collaboration of task assignment in accordance with an embodiment;

FIG. 4 is a table for an online collaboration of task assignment in accordance with an embodiment; and

FIG. 5 is another table for an online collaboration of task assignment in accordance with an embodiment.

### DETAILED DESCRIPTION

In accordance with embodiments of the disclosure, methods, systems, and computer program products for online collaboration of task assignment are provided.

In accordance with one or more embodiments, a system that monitors and analyzes statements of a virtual collaboration are described. In addition, this technique utilizes natural language phrase identification to assign tasks during the virtual collaboration or following the virtual collaboration. The system can recognize key phrases or a combination of key phrases that indicates that a participant has volunteered for a task or has accepted a task assignment. In one or more embodiments, a technique can be used for assigning tasks closely aligned with the participants' interests, experience, or competence. This technique can also identify key phrases from the natural language used in the virtual collaboration.

In addition, the object and subject keywords from task assignments are used to create a participant experience profile. The participant experience profile can be consulted to assign tasks with ambiguous ownership where the participant experience profile maintains a participant's task assignment history. If the ownership of a task cannot be determined from the context of the collaboration statement, a participant experience profile. A participant experience profile comprises a list of terms extracted from the statements and messages from the online collaboration where each participant had previously been assigned a task. The participant's experience score will be indexed for each object or subject that is indicated in the task. In the absence of any information in the participant experience profile, the task can be assigned based on the workload of the participants and given to the person with the least amount of active tasks. Responsive to historical assignments and newly assigned tasks an experience score of the participant experience profile can be updated to reflect the latest assignment. In a different embodiment, the total workload for each participant can be used as a factor to determine which participant should receive the task assignment.

In one or more embodiments, a participant experience profile is generated and used to assign various tasks to the participants. Each participant will be associated with a task assignment score and a participant having the highest match of scores will be assigned the task. In another embodiment, a count of the number of assigned tasks in the present collaboration and other open collaborations to ensure a single participant is not overloaded. In one or more embodiments, the tasks can be rebalanced among the participants based on each participant's workload.

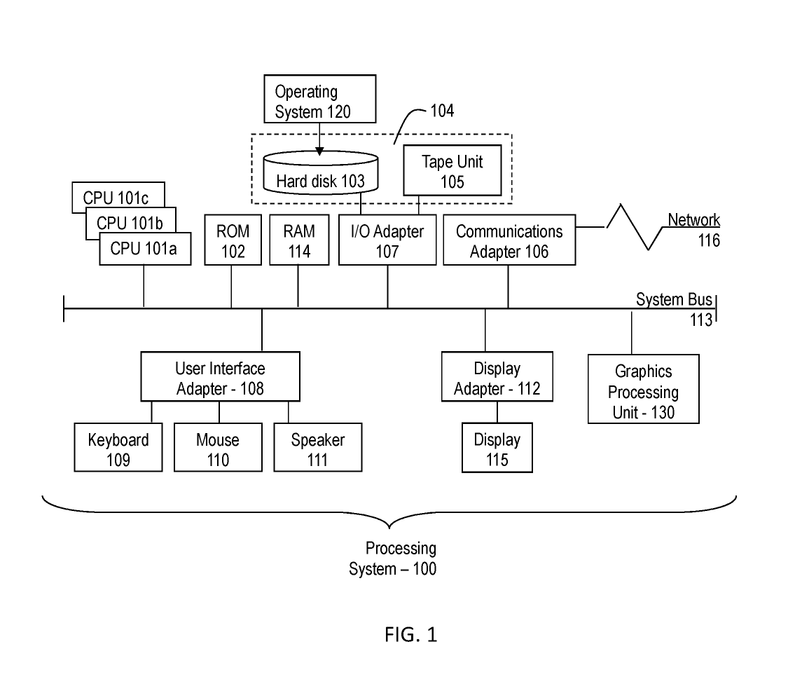

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

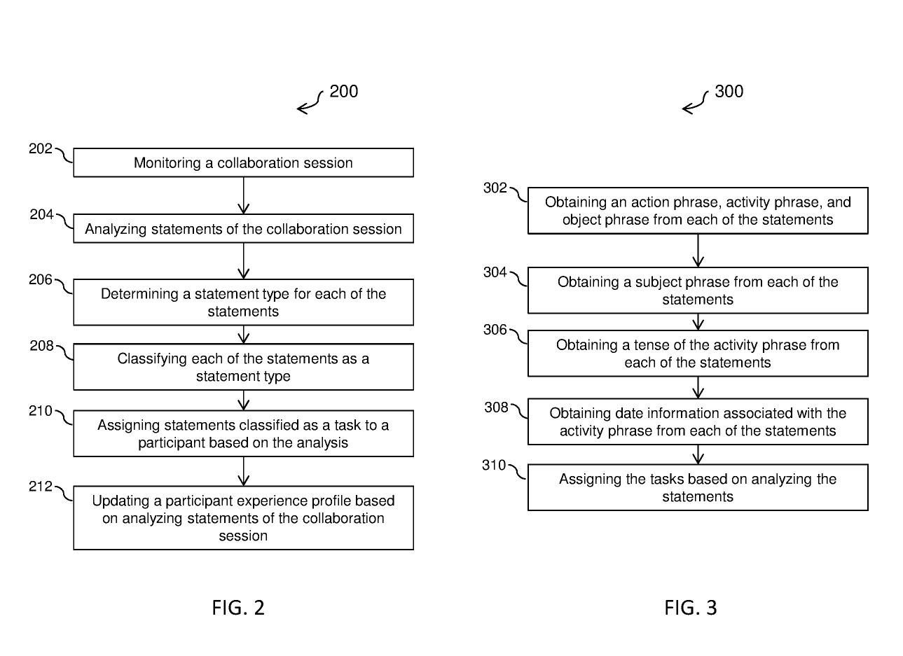

Now referring to FIG. 2, a flow diagram 200 for online collaborations task assignment is shown. Block 202 provides monitoring, by a processor, a collaboration session. In one or more embodiments, the collaboration can include a chat session, a web conference, teleconference, transcribed audio from face to face collaboration and/or any other type of virtual collaborations. The collaboration session can include real-time and non-real-time communications.

Block 204 provides analyzing statements of the collaboration session. In an embodiment, the collaboration session comprises a plurality of communications, messages, audio, etc. being exchanged among a plurality of participants. In accordance with a different embodiment, a transcript of an audio session from a teleconference or web conference can be analyzed.

Block 206 provides determining a statement type for each of the statements. In an embodiment, a statement type includes informational statements, questions, task statements, and the like. Block 208 provides classifying each of the statements as a statement type. In one or more embodiments, statements can be classified as questions, informational statements, and tasks based on the context of each statement. Statements that are classified as tasks can be assigned during the collaboration or assigned after the close of the completion to the participants in accordance with one or more embodiments.

Block 210 provides assigning each of the statements classified as a task to a participant based on the analysis. In one or more embodiments, the tasks that have been discussed in the collaboration session can be automatically assigned to participants in real-time as the collaboration is taking place or subsequently assigned after the close of the virtual collaboration. The system is capable of analyzing the context of the statements to assign the tasks. The context of the statement includes determining action phrases, activity phrases, object phrases and subject phrases and considering the combination of phrases to determining if a task exists from the statement.

Block 212 provides updating a participant experience profile based on analyzing statements of the collaboration session. In one or more embodiments, a participant experience profile includes information indicating past tasks a participant has been assigned and a participant experience score that represents the number of times a participant has been assigned a particular task. In addition, the participant experience profile can include a list associated with a specific time interval for determining the participant's experience with a specific task. For example, tasks that have not been discussed in over a year can be discounted from the participant experience profile. In another embodiment, older tasks can be given less weight than recently assigned tasks when calculating each participant's experience score.

Now referring to FIG. 3, a flow diagram 300 in accordance with an embodiment is shown. Block 302 provides obtaining an action phrase, activity phrase, and object phrase from each of the statements. In one or more embodiments, multiple action phrases, activity phrases, and object phrases can be determined from a single statement.

Block 304 provides obtaining a subject phrase from each of the statements. Block 306 provides obtaining a tense associated with the activity phrase from each of the statements. The tense associated with the activity phrase can indicate whether a certain activity has been completed or is to be completed in the future. In an embodiment, the activity phrase can be searched for an “-ed” suffix to determine a tense of the activity such as “booked.”

Block 308 provides obtaining date information associated with the activity phrase from each of the statements. In an embodiment, date information includes language such as “last week,” “yesterday,” “today,” “tomorrow,” etc. In a different embodiment, the date information can include other types of temporal information including specific dates. In addition, the date information associated with a statement may be unknown. Block 310 provides assigning the tasks based on analyzing the statements.

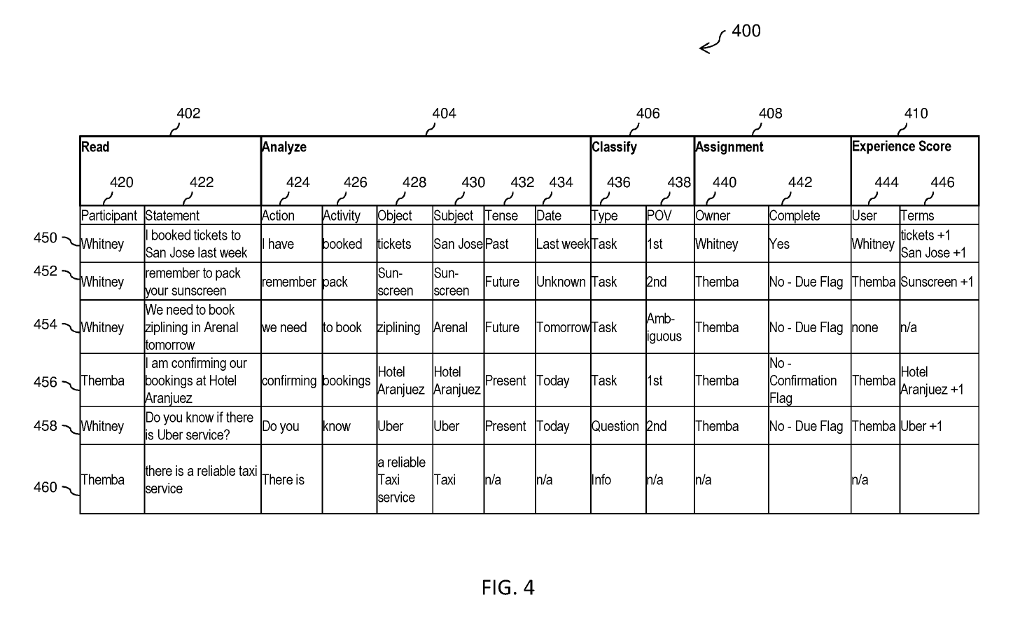

A sample chat transcript is provided below and analyzed with reference to table FIG. 4 in accordance with one or more embodiments.
(1) Whitney: “I booked tickets to San Jose last week, remember to pack your sunscreen!”
(2) Whitney: “We need to book Ziplining in Arenal tomorrow”
(3) Themba: “I am confirming our bookings at Hotel Aranjuez”
(4) Whitney: “Do you know if there is Uber service?”
(5) Themba: “No Uber, yet but there is a reliable taxi service”
(6) Whitney: etc . . .

The sample chat transcript can be generated in real-time from a present collaboration session, or it can be analyzed after the collaboration has taken place. The chat transcript includes the identity of the author of each statement and the statement presented by each author.

As shown in FIG. 4, table 400 represents a table in accordance with an embodiment. Block 402 provides a monitoring step that obtains information from the collaboration including the participant 420 identity and the statement 422 of the collaboration associated with each participant.

Block 404 provides an analysis step where multiple pieces of information are collected from the collaboration statements. The information as provided in FIG. 4 includes action phrases 424, activity phrases 426, object phrases 428, subject phrases 430, the tense information 432 of each statement, and date information 434 associated with the statement.

Block 406 provides a classifying step where a statement type 436 and point-of-view POV 438 of the statement is determined. In an embodiment, a statement type 436 includes an information statement, task statement, question, and the like. In an embodiment, the point-of-view 438 includes a first person view, second person view, ambiguous, and/or unknown. The point-of-view 438 information provides the context of which participant should be assigned the task.

Block 408 provides an assignment step where a task is assigned to an owner 440 and an indication 442 for the completion of a task is set. In one or more embodiments, an owner can be a participant or non-participant of a virtual collaboration. Block 410 provides an experience score for a user 444 and terms (subject/object) 446 of each of the statements of the collaboration. An experience score can be incremented based on the subject/object of the statements.

Rows 450-460 provides the analysis of the sample chat for lines 1-6 of the sample chat above in accordance with an embodiment. Row 450 provides the virtual collaboration participant 420 is Whitney and the statement 422 of the virtual collaboration provided by Whitney is “I booked tickets to San Jose last week.” The action phrase 424 is “I have,” the activity phrase 426 is “booked,” and the object phrase 428 is “tickets.” The subject phrase 430 is “San Jose” and the tense 432 of the activity phrase is the “past tense.” The date information 434 is “last week.” The statement type 436 is determined to be a “task” and the POV 438 is the first person for the participant is Whitney. The task of statement 422 is assigned to Whitney and is the owner 440 of the task. The task is indicated as completed in block 442. As a result of statement 422, a participant experience score is updated. The participant experience score for the user “Whitney” 444 and the score for the terms (object/subject) 446 associated with the participant experience score is incremented as shown in table 400. Based on statement 422, the score for tickets and San Jose is incremented and maintained for future task assignments. Row 452 provides an analysis for a portion of the statement (1) of the sample chat transcript.

Row 454 includes a collaboration statement that was presented by the participant 420 Whitney. In statement 422 Whitney states, “We need to book ziplining in Arenal tomorrow.” The action phrase 424 “we need” indicates a necessity to take action. An activity phrase 426 “to book” is obtained from the statement which refers to the object phrase 428 ziplining. The tense of the activity phrase 426 indicates a future event and date information 434 indicates “tomorrow” as a date for executing the statement. The statement type 436 provides the statement type is a task to be assigned.

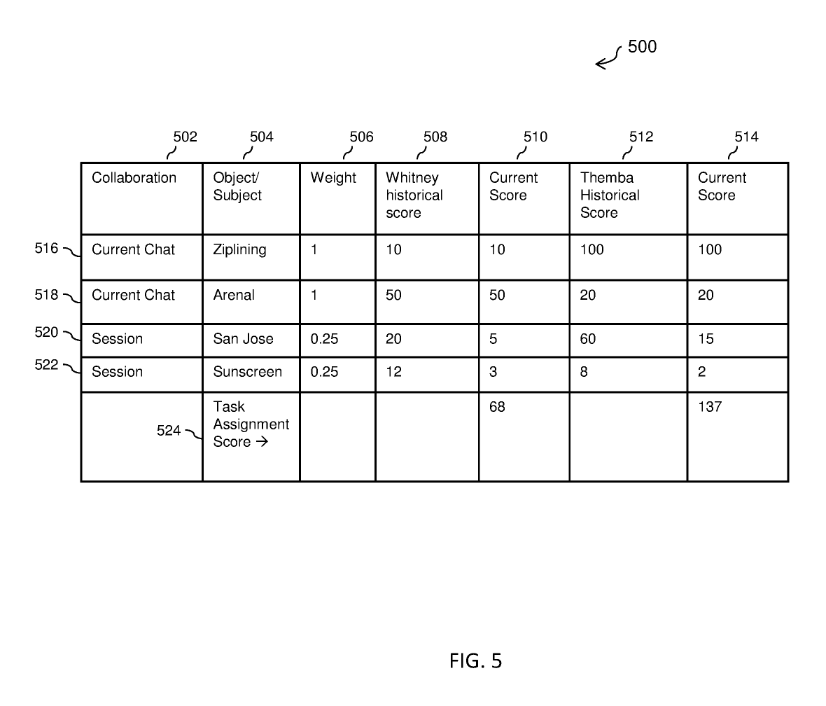

Based on the analysis of the statement of row 454, it is difficult to determine which participant should be assigned the task. In an embodiment, when the owner of the task is ambiguous a participant experience profile (as shown in FIG. 5) is referenced to determine the task assignment. In one or more embodiments, a participant experience profile includes historical information including object/subject of each statement, weight information, historical score, current score, and a task assignment score.

In accordance with an embodiment, Themba is assigned the task and determined to be the owner 440 of the task. The analysis will be explained subsequently. The completion indicator 442 provides the task for booking the ziplining has not been completed and a due flag can be set indicating the status. The status can be transmitted to the participants and used to update their calendars and task lists based on the status of the assignment. Rows 456, 458, and 460 provide an analysis for statements (3), (4), and (5), respectively.

FIG. 5 provides a table 500 in accordance with an embodiment for online collaboration of task assignment. FIG. 5 provides an example where ownership of a task is ambiguous and an assignment needs to be determined. Table 500 provides an example of a participant experience profile that is generated for the participants of the collaboration for the sample chat transcript provided above. In an embodiment, the participant experience profile is referenced when ownership of a task is unable to be determined. Column 502 provides a collaboration type. Column 504 provides the object/subject from a statement of the collaboration. Column 506 provides a weight applied to a historical score 508, 512. In one or more embodiments, the weight 504 can be determined and configured by the system or system operator. The weight 504 serves as a multiplier for calculating a final score. In columns 508, 512 a historical score for participants Whitney and Themba is provided. In one or more embodiments, each time an activity for a participant has been assigned and the historical score can be incremented by 1 for each instance. A current score 510 and 514 can be calculated for each participant in this example. In one or more embodiments, one or more participants can be included in the participant experience profile and one or more object/subjects can be included in table 500.

Row 516 provides a record for the participants associated with ziplining. In an embodiment, Whitney has been assigned a task for ziplining on 10 previous occasions while Themba has been assigned a task for ziplining on 100 previous occasions. As a result, Themba has a higher current score for ziplining which can indicate that he has more experience with ziplining. A similar analysis for row 518 is provided in FIG. 5.

Row 518 provides a record for each participant with regards to San Jose. In an embodiment, Whitney has been assigned a task associated with San Jose on 20 previous occasions, while Themba has been assigned a task associated with San Jose on 60 previous occasions. As a result, Themba has a higher current score for tasks associated with San Jose which can indicate Themba has more experience with San Jose. The weight 506 associated with each statement can be configured based on the timing of the statement. For example, a task assigned in a current collaboration can be given more weight than a task from a previous session. A similar analysis is performed for rows 520, 522.

Row 524 includes a task assignment score. The task assignment score is the sum total of the respective scores for each participant. In this example, the task assignment score for Whitney is 68 and the task assignment score for Themba is 137. In an embodiment, table 500 can be used to resolve the ambiguous assignment for ziplining. Themba will be assigned the task of ziplining because he has the higher task assignment score. In an embodiment, Themba can be sent a message or notification indicating the assignment. In one or more embodiments, the participants' calendars can be updated for all participants or a task list indicating the assignment and nag features to remind owners of tasks can be part of the calendar functions. Also, after an assignment of the task the participant experience profile can be updated to reflect the latest assignment. In an embodiment, if a participant accepts or volunteers for an event the score will be incremented. In one or more embodiments, the score can be decremented based on a user declining to do a task.

In an embodiment, during classification the statement can be classified as a task, question, or information as examples. In one or more embodiments, during the classification the point-of-view for the statement is determined. For example, if the statement is presented in the first person such as using “I” the statement will be associated with the speaker. If the statement is presented in the second person, the statement can be associated with another participant in the collaboration or a non-participant. If a non-participant is associated with the task, an INVITE message can be transmitted to the non-participant to join the current collaboration. Alternatively, an UPDATE message can be transmitted to the participant or non-participant when a task is assigned to the respective participant or non-participant.

Subsequent to determining a task, the task will be assigned to a participant. Prior to the assignment, it must be determined whether the task has been completed. The statement can be scanned for a temporal indication for completing or completion of a task. The task can be a task to be completed in the future, currently in-process, or previously completed. In an embodiment, when a task is determined to be performed in the future a due date flag can be set and transmitted to the participant based on the indication.

In one or more embodiments, if it cannot be determined who should be assigned a task the assignment is determined ambiguous. This scenario can occur in an example where the perspective cannot be determined or when multiple participants are in a collaboration and it is unclear who should be assigned the task. In an embodiment, when an ambiguous condition exists, the Experience Participant Profile will be referenced to determine the assignment of the task.

In one or more embodiments, a task that has been located in a current chat can receive a higher weight than a task that has been previously located in a previous session or chat. The weight can be used as a multiplier to determine a current participant experience score for each participant.

The historical score is associated with a participant having been previously assigned a task. Each time a participant has been assigned a task, the historical score can be incremented. In an embodiment, the historical score can be incremented by 1 for each previous instance the task was assigned.

A current score can be calculated for a task for a participant by multiplying the historical score by the weight of the task. A task assignment score can then be calculated by adding all of the current scores of a respective participant. In an embodiment, the participant with the highest participant score will be assigned the task. In this particular example, Themba, having a task assignment score of 137, will be assigned the ziplining task based on the user's experience profile, Themba is likely to have more experience with ziplining than Whitney.

The assignment of tasks can be determined in various ways. In an embodiment, tasks can be assigned based on the number of assigned tasks for present and other open collaborations. The number of assigned tasks for each of the participants and potential non-participants can be compared to determine an individual with the least number of assigned tasks. In one or more embodiments, tasks can be manually assigned where the manual assignment can override an assignment from the system. The manual assignment can be performed by an operator or the system.

In one or more embodiments, the assignments can be based on an expressed interest by a participant or non-participant. In a different embodiment, assignments can be delegated according to a strength-based assignment, where the expertise of each participant and non-participant can be considered for assigning the task. The strength or expertise of a participant can be gleaned from the participant experience profile.

In one or more embodiments, a participant can express an interest or preference in a particular task and the assignment of the task can be based on a participant volunteering for the task. In a different embodiment, the interest, preference, or expertise can be expressed for a field or a topic or subject matter.

In one or more embodiments, a task count can be maintained for all previously assigned tasks. In a different embodiment, a task count can also be maintained for the current number of active assigned tasks, where the previously completed tasks will not be considered in the task count but will be considered in effecting the participant experience profile score. In an embodiment, a participant with the smallest task count can be assigned the task. In another embodiment, the difficulty of the tasks and the task count can be considered for task assignment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for online collaboration of task assignment, the method comprising:
monitoring a collaboration session;
analyzing statements of the collaboration session;
determining a statement type for the statements of the collaboration session;
classifying the statements as a statement type;
assigning statements classified as a task to a participant based on the analysis; and
updating a participant experience profile based on analyzing statements of the collaboration session.

2. The method of claim 1, wherein analyzing the statements comprises obtaining an action phrase, activity phrase, and object phrase from each of the statements;
obtaining a subject phrase from each of the statements;
obtaining a tense of the activity phrase from each of the statements; and
obtaining a date associated with the activity phrase from each of the statements.

3. The method of claim 1, wherein classifying the statements comprises determining a task and “point of view” for each of the statements; and
responsive to not determining a “point of view” of the statement, assigning tasks based on the participant experience profile.

4. The method of claim 1, wherein assigning comprises determining a participant or non-participant to assign a task and indicating a status of the task.

5. The method of claim 1, wherein updating the participant experience profile comprises updating a participant experience score;
wherein the participant experience profile comprises objects and subjects of the statements for which each respective user has previously been assigned tasks and a participant experience score; and
updating the participant experience score based on being assigned a task.

6. The method of claim 1, in the absence of a participant experience profile, assigning a task to the participant with a least amount of active assigned tasks in the collaboration session and all other collaboration sessions.

7. The method of claim 1, wherein assigning tasks is based on a participant having a highest match of scores.

8. The method of claim 1, wherein assigning tasks to a participant is based on a number of assigned tasks in a present collaboration and other open collaborations for each participant.

9. A system for online collaboration of task assignment, the system comprises:
a memory coupled to a processing engine, the processing engine configured to:
monitor a collaboration session;
analyze statements of the collaboration session;
determine a statement type for the statements of the collaboration session;
classify the statements as a statement type;
assign statements classified as a task to a participant based on the analysis; and
update a participant experience profile based on analyzing statements of the collaboration session, the participant experience profile comprises a participant experience score.

10. The system of claim 9, wherein analyzing the statements comprises obtain an action phrase, activity phrase, and object phrase from each of the statements;
obtain a subject phrase from each of the statements;
obtain a tense of the activity phrase from each of the statements; and
obtain a date associated with the activity phrase from each of the statements.

11. The system of claim 9, wherein classifying the statements comprises determining a task and “point of view” for each of the statements; and
responsive to not determining a “point of view” of the statement, assigning tasks based on the participant experience profile.

12. The system of claim 9, wherein assigning comprises determining a participant or non-participant to assign a task and indicating a status of the task.

13. The system of claim 9, wherein updating the participant experience profile comprises updating a participant experience score;
wherein the participant experience profile comprises objects and subjects of the statements for which each respective user has previously been assigned tasks and a participant experience score; and
updating the participant experience score based on being assigned a task.

14. The system of claim 9, in the absence of a participant experience profile, assigning a task to the participant with a least amount of active assigned tasks in the collaboration session and all other collaboration sessions.

15. The system of claim 9, wherein assigning tasks is based on a participant having a highest match of scores.

16. The system of claim 9, wherein assigning tasks to a participant is based on a number of assigned tasks in a present collaboration and other open collaborations for each participant.

17. A computer program product for online collaboration of task assignment, the computer program product comprising:
a computer readable storage medium having stored thereon program instructions executable by a processor to cause the processor to:
monitor a collaboration session;
analyze statements of the collaboration session;
determine a statement type for the statements of the collaboration session;
classify the statements as a statement type;
assign statements classified as a task to a participant based on the analysis; and
update a participant experience profile based on analyzing statements of the collaboration session, the participant experience profile comprises a participant experience score.

18. The computer program product of claim 17, wherein analyzing the statements comprises obtain an action phrase, activity phrase, and object phrase from each of the statements;
obtain a subject phrase from each of the statements;
obtain a tense of the activity phrase from each of the statements; and
obtain a date associated with the activity phrase from each of the statements.

19. The computer program product of claim 17, wherein classifying the statements comprises determining a task and “point of view” for each of the statements; and
responsive to not determining a “point of view” of the statement, assigning tasks based on the participant experience profile.

20. The computer program product of claim 17, wherein updating the participant experience profile comprises updating a participant experience score;
wherein the participant experience profile comprises objects and subjects of the statements for which each respective user has previously been assigned tasks and a participant experience score; and
updating the participant experience score based on being assigned a task.
